(19) United States
(12) Patent Application Publication
(10) Pub. No.: US 2003/0018538 A1
(43) Pub. Date: Jan. 23, 2003

(54) System and method of intermediating sales

(76) Inventors: Seiichi Tomita, Yokohama (JP); Fumihiko Iwabuchi, Yokohama (JP); Tomihiko Kakuta, Yokohama (JP); Yukio Hayashi, Tokyo (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/012,777

(22) Filed: Dec. 10, 2001

Related U.S. Application Data
(63) Continuation of application No. 09/994,952, filed on Nov. 27, 2001.

(30) Foreign Application Priority Data
Jul. 19, 2001 (JP) P2001-219874

(51) Int. Cl. G06F 17/60

(52) U.S. Cl. 705/26

(57) ABSTRACT

Sales of products including consumables and supply parts often involve brokers or intermediary agents who interface consumers and manufacturers. A sales broker system and method of intermediating goods facilitate joint purchases of products, provide manufactures and suppliers with information on market accumulated by the sales brokers, as well as distribute sales information on new products. The joint purchase is managed by the intermediary in an efficient manner so that the consumer unit price is reduced. The market information is also managed by the intermediary so that the manufacturers enjoy accurate sales information based upon actual deliveries. Finally, the intermediary also facilitate to transmit the information on new products to target or potential clients.

### FIELD OF THE INVENTION

The current invention is generally related to intermediating sales of products including consumables and supply parts, and more particularly related to a sales broker system and method of facilitating joint purchases of products, providing manufactures and suppliers with information on market accumulated by the sales brokers, as well as distributing sales information on new products.

### BACKGROUND OF THE INVENTION

When a manufacturer and a client directly negotiate sales, the manufacturer generally maintain a database for the delivered product information as well as maintenance and operational information of the product. Based upon the above information, the manufacturer determines expected dates for exchanging the product as well as refilling supply and notifies the customers for the expected dates in order to prompt purchase orders. Similarly, for malfunctions that are caused by parts exchange as well as supply, the manufacturer also determines expected dates and proposes the customers the repair, supply and exchange on the expected dates in order to prompt purchase orders.

For low cost purchases of merchandises, Japanese Patent Publication Hei 2000-99579 discloses that brokers publish the sales items that manufacturers offer at the brokers' web sites. Purchasers access to the brokers' web site to obtain the sales information and make purchases.

For joint purchases of merchandises, customer bulletin boards or forums ask for customers who are interested in purchasing the same merchandises. When there is a sufficient number of customers or a sufficient amount of purchase, an operator of the bulletin boards or forums negotiates on the production and the costs based upon the above purchase and the delivery date with a specified manufacturer.

For block sales of merchandises, Japanese Patent Publication Hei 10-320470 discloses that a seller registers unit prices for block sales of various sizes at an intermediary web site. Purchasers access the intermediary web site to determine purchases based upon the block size costs.

Finally, manufacturers and suppliers purchase market information from sales companies that deal with multiple suppliers and manufacturers. The purchased market information includes repeat order probability and customer data that indicates switching from a particular manufacturer or a supplier to another.

### SUMMARY OF THE INVENTION

In order to solve the above and other problems, according to a first aspect of the current invention, a system for intermediating sales between merchandise manufacturers and clients, including: a merchandise manufacturer processing unit for interfacing with the manufacturers; a client processing unit for interfacing with the clients; and an intermediary processing unit connected to the merchandise manufacturer processing unit and the client processing unit further including: a database manager for maintaining a database that contains sales information of merchandises to the clients from the merchandise manufacturers; an exchange/supply determination unit connected to the database manager for determining a purchase reminder date for certain merchandises for each of the clients, the exchange/supply determination unit transmitting a purchase reminder for the certain merchandises to corresponding ones of the clients at a predetermined amount of time prior to the purchase reminder date; an order request receiving unit connected to the client processing unit for receiving purchase orders from the clients in response to the purchase reminder and for summing the purchase orders based upon predetermined criteria for a joint purchase; and a joint purchase processing unit connected to the order request receiving unit for requesting estimates from at least one of the merchandise manufacturers for the joint purchase at a reduced unit price.

According to a second aspect of the current invention, system for generating market information in intermediating sales between merchandise manufacturers and clients, including: a merchandise manufacturer processing unit for interfacing with the manufacturers; a client processing unit for interfacing with the clients; and an intermediary processing unit connected to the merchandise manufacturer processing unit and the client processing unit further including: a database manager for maintaining a database that contains sales information of merchandises to the clients from the merchandise manufacturers; an order request receiving unit connected to the client processing unit for receiving purchase orders from the clients and for generating deliver orders to the merchandise manufacturer processing unit based upon the purchase orders from the clients; and a delivery information processing unit connected to the merchandise manufacturer processing unit for receiving delivery results information from the merchandise manufacturers after the merchandise manufacturers deliver the merchandises to the clients; and a market information processing unit connected to the delivery information processing unit for generating market information based upon the delivery results information and the sales information.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating one preferred embodiment of the merchandise intermediary system according to the current invention.

FIG. 2 includes tables illustrating an exemplary portion of the merchandise/product information or database that is used with the preferred embodiment according to the current invention.

FIG. 3 is a table illustrating an exemplary portion of the client information that is used with the preferred embodiment according to the current invention.

FIG. 4 includes tables illustrating an exemplary portion of the unit operation information or database 201 that is used with the preferred embodiment according to the current invention.

FIG. 5 includes tables illustrating an exemplary portion of the follow-up client information or database that is used with the preferred embodiment according to the current invention.

FIG. 6 includes tables illustrating an exemplary portion of the purchase history information or database that is used with the preferred embodiment according to the current invention.

FIG. 7 is a flow chart illustrating steps involved in a preferred process of registering information at the merchandise/product information or database according to the current invention.

FIG. 8 is a flow chart illustrating steps involved in a preferred process of registering information at the unit operation database and the client database according to the current invention.

FIG. 9 is a flow chart illustrating steps involved in a preferred process of jointly purchasing supply parts according to the current invention.

FIG. 10 is a flow chart further illustrating detailed steps involved in a preferred process of the merchandise order as shown in the step 22 of FIG. 9 according to the current invention.

FIG. 11 is a flow chart further illustrating detailed steps involved in a preferred process of the vendor selection as shown in the step S24 of FIG. 9 according to the current invention.

FIG. 12 include flow charts further illustrating detailed steps involved in preferred processes of speculating the supply parts replenishment date as shown in the step S29 of FIG. 9 according to the current invention.

FIG. 13 is a flow chart further illustrating steps involved in a preferred process of matching negotiations according to the current invention.

FIG. 14 is a flow chart and a diagram further illustrating detailed steps involved in preferred processes of the step S43 of FIG. 13 according to the current invention.

FIG. 15 is a flow chart illustrating steps involved in a preferred process of generating market information according to the current invention.

### DETAILED DESCRIPTION OF THE PREFERRED EMBODIMENT(S)

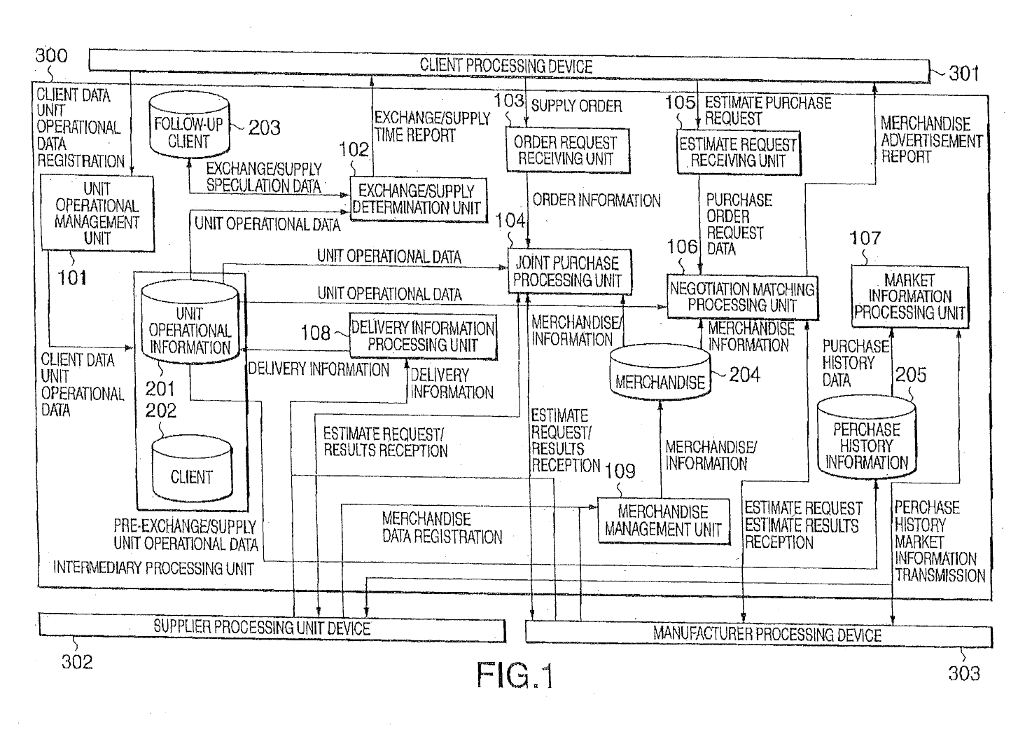

Referring now to the drawings, wherein like reference numerals designate corresponding structures throughout the views, and referring in particular to FIG. 1, a diagram illustrates one preferred embodiment of the merchandise intermediary system according to the current invention. The preferred embodiment includes an intermediary processing device 300, a client processing device 301, a supplier processing device 302 and a manufacturer processing device 303. In general, the intermediary processing device 300 distributes to customers or clients sales information on products, parts and supplies from a plurality of manufacturers and suppliers via a network. On the other hand, the client processing device 301 receives reports or purchase reminders for exchanging products and replenishing supplies from the intermediary processing device 300 via the network and orders the reminded items or the estimates to the intermediary processing device 300. The supplier processing device 302 receives the supply orders and estimates from the intermediary processing device 300 via the network and responds to the above requests. The manufacturer processing device 303 similarly receives the product orders, delivery requests and estimates from the intermediary processing device 300 via the network and responds to the above requests.

Still referring to FIG. 1, the intermediary processing device 300 further includes a unit operational management unit 101, an exchange/supply determination unit 102, a supply order unit 103, a joint purchase processing unit 104, an estimate/order request receiving unit 105, a negotiation matching processing unit 106, a market information processing unit 107, a delivery information processing unit 108 and a merchandise management unit 109. The unit operational management unit 101 processes and manages information on components or units of a merchandise, operation of the merchandise and maintenance on the product. The unit operational management unit 101 also processes and manages information on customers who utilize products that compete with the ones as indicated in the information from suppliers and manufacturers. The exchange/supply determination unit 102 calculates the date when a certain product needs to be changed or replenished. If the calculated date is within a predetermined period of time, the exchange/supply determination unit 102 sends a purchase reminder about the exchange or refill to the client processing device 301. To determine the product exchange date, the exchange/supply determination unit 102 refers to a product installment date and an average product life. Similarly, to determine the parts exchange date, the exchange/supply determination unit 102 relies upon maintenance performed dates, average in-between malfunction length and a number of repairs. Lastly, to determine the supply replenish dates, the exchange/supply determination unit 102 refers to supply purchased dates, supply purchased amounts and average use amounts. The supply order unit 103 receives the orders that are transmitted by the client processing device 301 after the exchange/supply reminders has been sent from the exchange/supply determination unit 102. The joint purchase processing unit 104 receives the orders from the supply order unit 103 and totals the orders from a plurality of the client processing units 301 as a joint order. The joint purchase processing unit 104 requests an estimate for the joint order and functions as an intermediary for the joint purchase of a product, a part or a supply.

Other components of the intermediary processing device 300 provides the following functions. The estimate/order request receiving unit 105 receives and manages the purchase orders and the delivery requests for the products from the client device 301. In one aspect, the negotiation matching processing unit 106 receives the estimates requests and the orders from the estimate/order request receiving unit 105 and functions as an intermediary by proposing to certain ones of the client units 301 the estimates from a plurality of the manufactures and or suppliers who responded to the estimate requests. In another aspect, the negotiation matching processing unit 106 is to function as an intermediary by proposing the above same estimates to other clients who use competing products of the above responded manufacturers and suppliers according to the product information from the manufacturers and suppliers. The market information processing unit 107 manages the purchase history information and generates market information such as repeat or continuous purchases of certain products. The market information processing unit 107 transmits the above generated market information to the supplier processing device 302 and the manufacturer processing device 303. The delivery information processing unit 108 updates the unit/component information and or the unit operation information based upon the results of the delivery by the suppliers and the manufacturers to the clients. The merchandise management unit 109 manages main product information such as functions, performance, a product life, an average in-between repair length, a number of repairs, product-supply chart and competing products based upon the information from the suppliers and the manufacturers.

One implementation of the preferred embodiment is a computer program. The computer program enables the intermediary processing device 300 as the unit operational management unit 101, the exchange/supply determination unit 102, the supply order unit 103, the joint purchase processing unit 104, the estimate/order request receiving unit 105, the negotiation matching processing unit 106, the market information processing unit 107, the delivery information processing unit 108 and the merchandise management unit 109. The computer program is stored in a recording media such as CD-ROM and is executed after being read into memory. The above computer program is stored in any recording medium or alternatively is installed in the intermediary processing device 300. The above computer program is also implemented to be available through the network.

Still referring to FIG. 1, the intermediary processing device 300 further includes databases such as unit operation information or database 201, client information or database 202, follow-up client information or database 203, merchandise/product information or database 204 and purchase history information or database 205. The unit operation information 201 is a database that contains components and operation information of the product that each client utilizes. The client information 202 is a database for managing client information such as client names, addresses and phone numbers. The follow-up client information or database 203 is a database for managing a part of the client information representing clients who require the exchange of the products by a certain time, the necessary product volume and the time frame. The merchandise/product information or database 204 is a database for managing information on merchandises sold by manufacturers and suppliers, product-supply compatibility, and competing products. The purchase history information 205 is a database for managing purchase history. In the above and following, the term, merchandise is meant to include products, supply parts and parts.

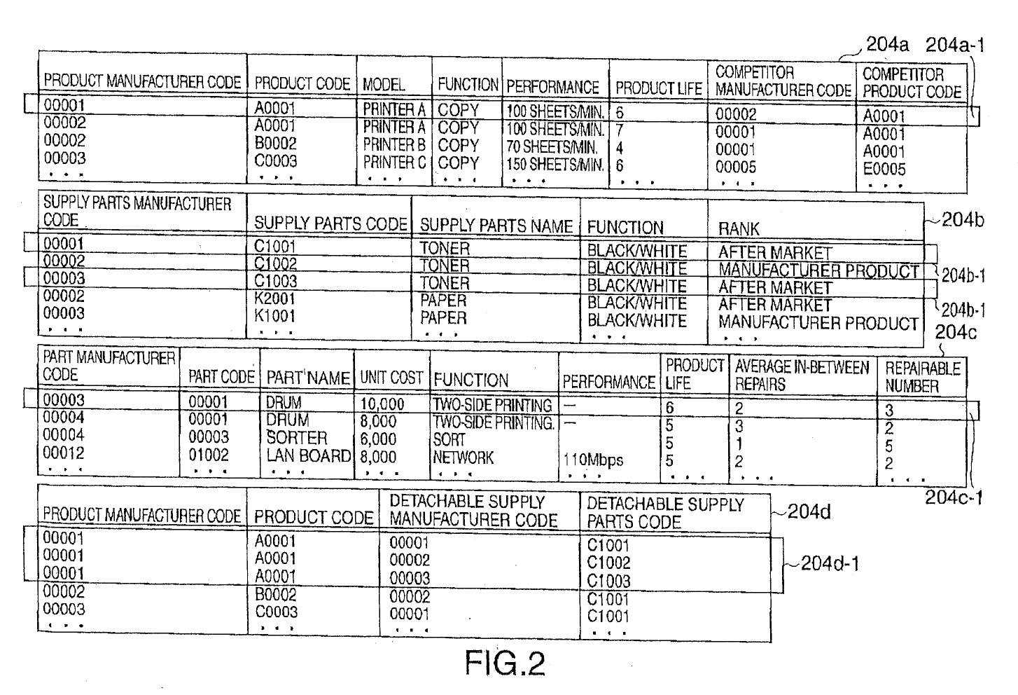

Now referring to FIG. 2, tables illustrate an exemplary portion of the merchandise/product information or database 204 that is used with the preferred embodiment according to the current invention. The tables include information on merchandises that manufacturers and suppliers sell, supply parts and parts, product-supply compatibility and competing merchandise as well as own merchandise. The product table 204a includes information on product manufacturer code, product code, model, function, performance, product life, competitor code and manufacturer competitor product code. The supply parts table 204b includes information on supply parts manufacturer code, supply parts code, supply parts names, functions and rank. The supply parts rank has values such as original “Manufacturer's Product” and compatible “After Market” product. The part table 204c includes information on parts manufacturer code, part code, part names, functions, performance, part life, average in-between repairs and a number of repairable times or numbers. The product-supply parts compatibility table 204d includes information on product manufacturer code, product code, detachable supply parts manufacturer code and detachable supply parts code.

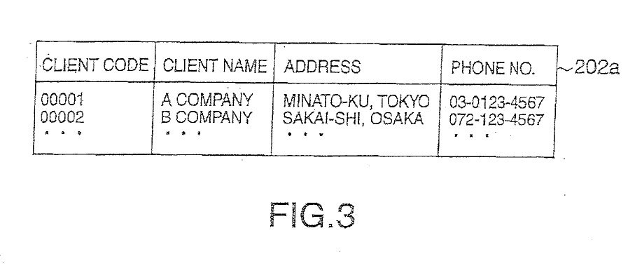

Referring to FIG. 3, a table illustrates an exemplary portion of the client information 202 that is used with the preferred embodiment according to the current invention. The client table 202a includes information on client code, client names, addresses and phone numbers.

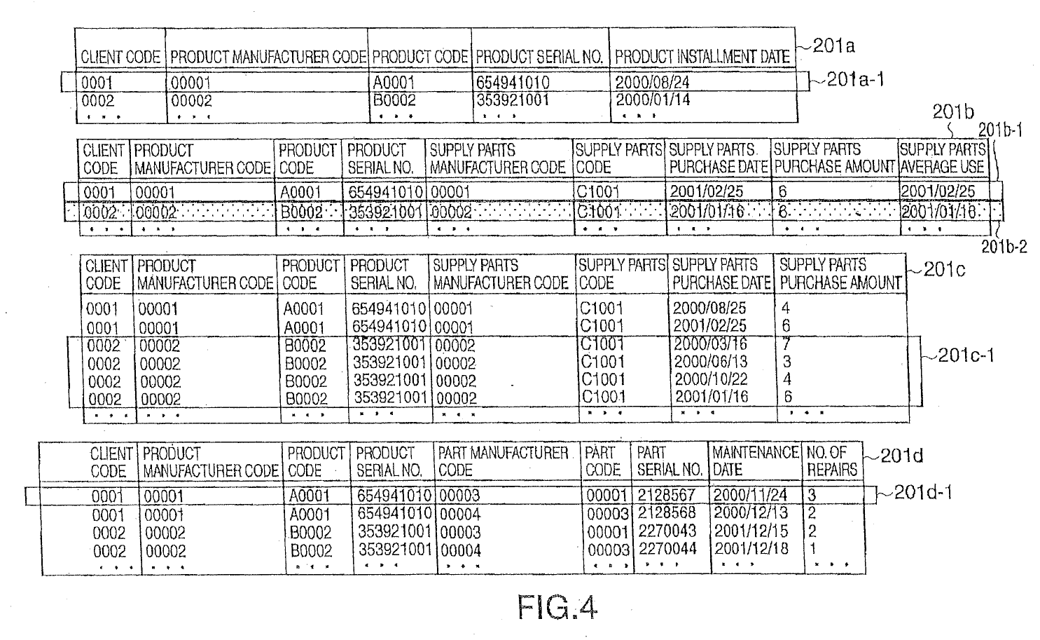

Now referring to FIG. 4, tables illustrate an exemplary portion of the unit operation information or database 201 that is used with the preferred embodiment according to the current invention. The tables include information on delivered product components, product operation and product maintenance. A unit component product table 201a manages information on the delivered products and includes information on client code, product manufacturer code, product code, product serial numbers and product installation dates. A supply parts table 20lb manages information on the delivered products and compatible supply parts and includes information on client code, product manufacturer code, product code, product serial numbers, supply parts manufacturer code, supply parts code, supply purchase dates, supply purchase amounts and supply parts average use amounts. The operational information table 201c manages operational information on the delivered products and the supply replenish history and includes information on client code, product manufacturer code, product code, product serial numbers, supply parts manufacturer code, supply parts code, supply purchase dates and supply purchase amounts. The maintenance information table 201d manages maintenance information on the delivered products and includes information on client code, product manufacturer code, product code, product serial numbers, parts manufacturer code, parts code, part serial numbers, part maintenance dates and a number of repairs.

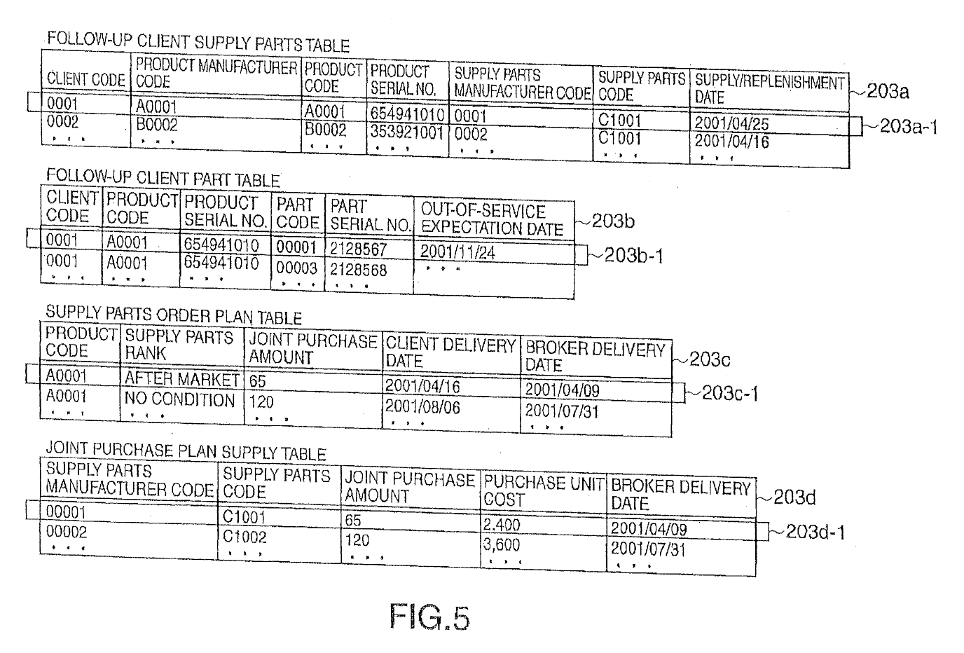

Now referring to FIG. 5, tables illustrate an exemplary portion of the followup client information or database 203 that is used with the preferred embodiment according to the current invention. The tables include information on the exchange date of the delivered products, replenishment expected dates and associated products that are due around the replenishment expected dates. The follow-up client supply parts table 203a includes information on client code, product manufacturer code, product code, product serial number, supply parts manufacturer code, supply parts code and supply parts replenishment dates. The follow-up client parts table 203b manages information on the clients who own parts to be exchanged and includes information on client code, product manufacturer code, product code, product serial numbers, part code, part serial numbers and out-of-service expectation dates. The supply parts order plan table 203c manages operational information on the total supply parts amount for a given time and includes information on product code, supply rank, joint purchase amounts, client delivery dates and broker/intermediary delivery dates. The joint purchase plan supply parts table 203d manages information on the supply parts to be jointly purchased from manufacturers and suppliers and includes information on supplier manufacturer code, supply parts code, joint purchase amounts, purchase unit cost and broker/intermediary delivery dates.

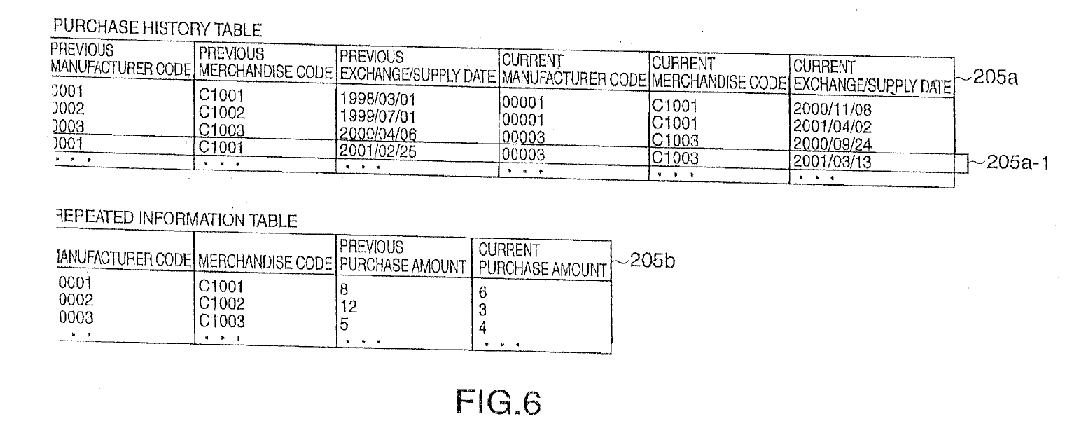

Referring to FIG. 6, tables illustrate an exemplary portion of the purchase history information or database 205 that is used with the preferred embodiment according to the current invention. The tables include information on clients' merchandise purchase history as well as repetitive or continuous purchases. The purchase history table 205a includes information on previously purchased manufacturer code, previously purchased merchandise code, previous exchange/supply dates, current merchandise code and current exchange/supply dates. The repeated information table 205b manages information indicative of the repeat purchase and includes information on product manufacturer code, merchandise code, previous purchase amounts and current purchase amounts.

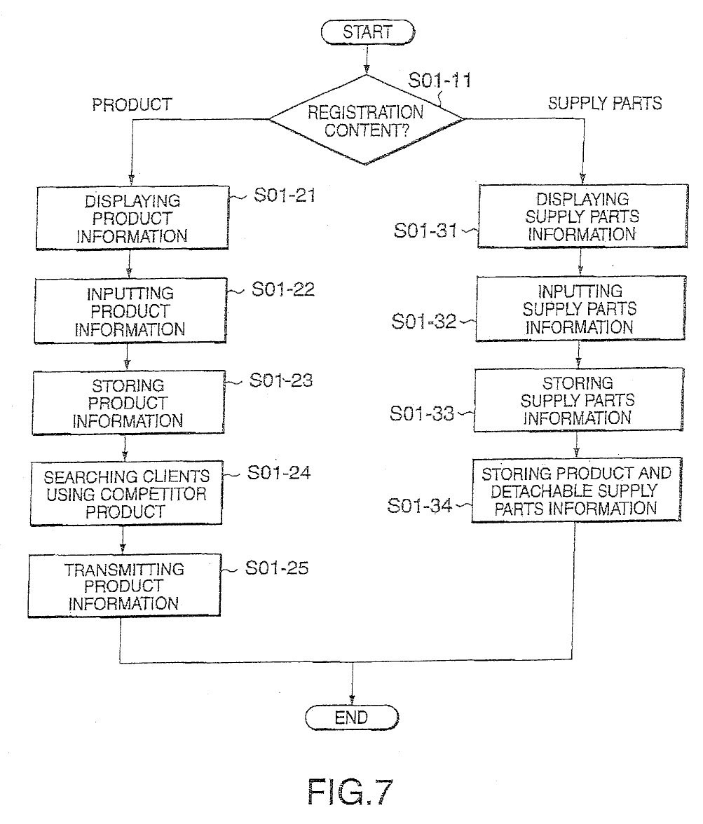

Now referring to FIG. 7, a flow chart illustrates steps involved in a preferred process of registering information at the merchandise/product information or database 204 according to the current invention. The steps will be described with respect to the above described components or units. In general, the merchandise management unit 109 of the intermediary processing device 300 receives information on the merchandise of the participating suppliers and manufacturers from the corresponding supplier processing units 302 and the corresponding manufacturer processing units 303 and stores the merchandise information at the merchandise/product information or database 204. The information to be registered includes the costs, functions and performance of the participating merchandise as well as product-supply compatibility data and competing manufacturer data. In a step S01-11, the supplier processing device 302 or the manufacturer processing device 303 displays a merchandise registration screen for selecting either a product registration or a supply registration. The supplier processing device 302 or the manufacturer processing device 303 subsequently receives an input signal indicative of a product registration or a supply part registration as determined by a merchandise data input operator. Based upon the input signal, the preferred process proceeds to branch. If it is determined that the input signal is indicative of the product registration, a product information registration screen is displayed in a step S01-21.

In the step S01-22, the manufacturer processing device 303 receives information on product manufacturer code, product code, model, function, performance, product life, competitor code and manufacturer competitor product code from the product information registration screen and transmits the received information to the intermediary processing device 300. Upon receiving the product information from the manufacturer processing device 303, the merchandise management unit 109 of the intermediary processing device 300 adds a record in the product table 204a and stores in the added record the receives information on product manufacturer code, product code, model, function, performance, product life, competitor code and manufacturer competitor product code in a step S01-23. The unit operational management unit 101 of the intermediary processing device 300 searches a matching one of the competitive manufacturer code and the competitive product code in the unit component product table 201a in order to obtain a corresponding one of the client code in a step S01-24. In other words, the above obtained client code represents a client who uses a competitor's product in lieu of the currently entered product. In a step S01-25, the negotiation matching processing unit 106 of the intermediary processing device 300 transmits the client who uses a competitor's product e-mail containing the sale information on the currently registered product. For example, assuming that a product called, “Printer A” from one company competes with a product called, “Printer B” from another company, sales information on Printer B is transmitted to a customer who uses Printer A.

On the other hand, when the supply part registration is selected in the step S01-11, the preferred process proceeds to a step S01-31 where a supply part information registration screen is displayed. In a step S01-32, the supplier processing device 302 receives information on supply parts manufacturer code, supply parts code, model, function, performance, rank, compatible product manufacturer code and compatible product code from the supply part information registration screen and transmits the received information to the intermediary processing device 300. Upon receiving the supply part information from the supplier processing device 302, the merchandise management unit 109 of the intermediary processing device 300 adds a record in the supply parts table 204b and stores in the added record the received information on supply parts manufacturer code, supply parts code, model, function, performance, rank, compatible product manufacturer code and compatible product code in a step S01-33. In a step S01-34, a new record is also added in the product-supply parts compatibility table 204d to store product manufacturer code, product code and detachable supply parts code. Although it is not shown in FIG. 7, the parts information is similarly registered.

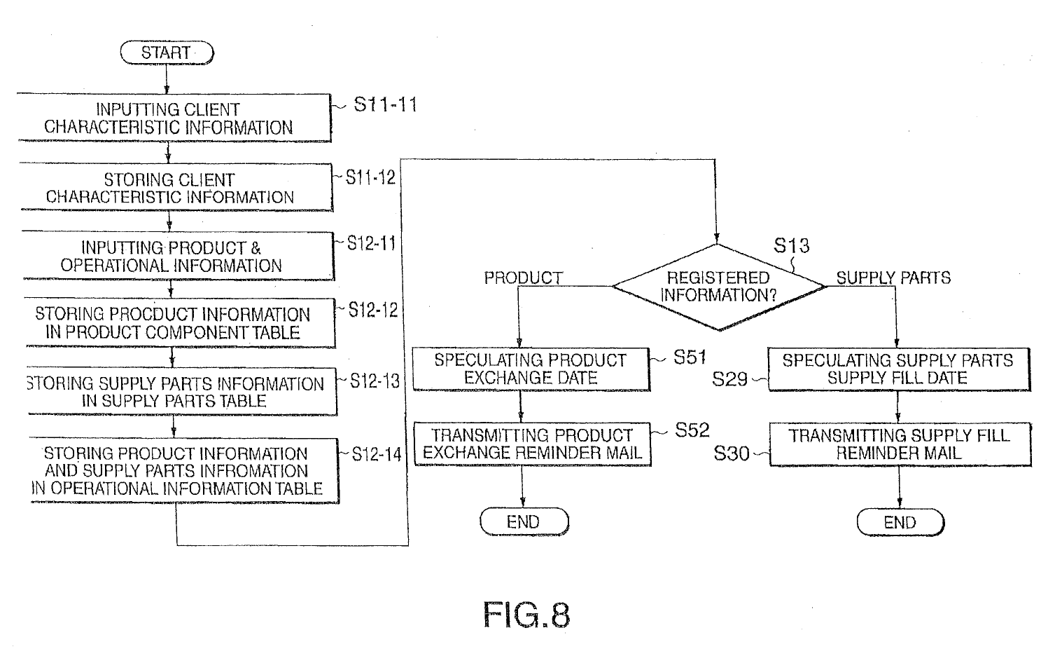

Now referring to FIG. 8, a flow chart illustrates steps involved in a preferred process of registering information at the unit operation database 201 and the client database 202 according to the current invention. The preferred process involves information registration, product exchange date determination as well as supply part replenishment date determination. The steps will be described with respect to the above described components or units. In a step S11-11, participating clients input client names, addresses and phone numbers via the client information registration screen of the client processing device 301. The client processing device 301 transmits the client information to the intermediary processing device 300. Upon receiving the above client information from the client processing device 301, the unit operational management unit 101 of the intermediary processing device 300 adds records in the client table 202a to store the received client information on client names, addresses and phone numbers in a step S11-12. Subsequently, the participating clients further input unit/component information of the product as well as operational information of detachable supply parts via the unit/operation information registration screen of the client processing device 301. In inputting the product information such as product manufacturer code and product code, correct information is selected from predetermined lists. Other product information such as product serial numbers and product installment dates are typed in. Similarly, in inputting the supply parts information such as supply parts manufacturer code and supply parts code, correct information is selected from predetermined lists. Other supply parts information such as supply part purchase dates and supply parts average use amounts are typed in. The client processing device 301 transmits the above inputted unit operation information to the intermediary processing device 300 in a step S12-11.

Still referring to FIG. 8, other steps proceed as follows: Upon receiving the unit operation information from the client processing device 301, the unit operational management unit 101 of the intermediary processing device 300 adds records in the unit component product table 201a to store the received information on client code, product manufacturer code, product code, product serial numbers and product installation dates in a step S12-12. Subsequently, the unit operational management unit 101 of the intermediary processing device 300 adds records in the supply parts table 201b to store the received information on client code, product manufacturer code, product code, product serial numbers, supply parts manufacturer code, supply parts code, supply purchase dates, supply purchase amounts and supply part average use amounts in a step S12-13. The unit operational management unit 101 of the intermediary processing device 300 adds records in the operational information table 201c to store the received on client code, product manufacturer code, product code, product serial numbers, supply parts manufacturer code, supply parts code, supply purchase dates and supply purchase amounts in a step S12-14.

In a step S13, the unit operational management unit 101 of the intermediary processing device 300 determines whether the unit component product table 201a or the supply parts table 20lb of the unit operation database 201 has been processed. In case a new record has been added to the unit component product table 201a, the exchange/supply determination unit 102 speculates the product exchange date in a step S51 based upon the product information that has been registered in the steps S12-11 through S12-14. Furthermore, in a step S52, the exchange/supply determination unit 102 transmits a corresponding client product exchange reminder e-mail one month prior to the speculated product exchange date. On the other hand, in case a new record has been added to the supply parts table 201b, the exchange/supply determination unit 102 speculates the supply replenish date in a step S29 based upon the supply parts information that has been registered in the steps S12-11 through S12-14. Furthermore, in a step S30, the exchange/supply determination unit 102 transmits a corresponding client supply parts replenish reminder e-mail one month prior to the speculated supply parts replenish date.

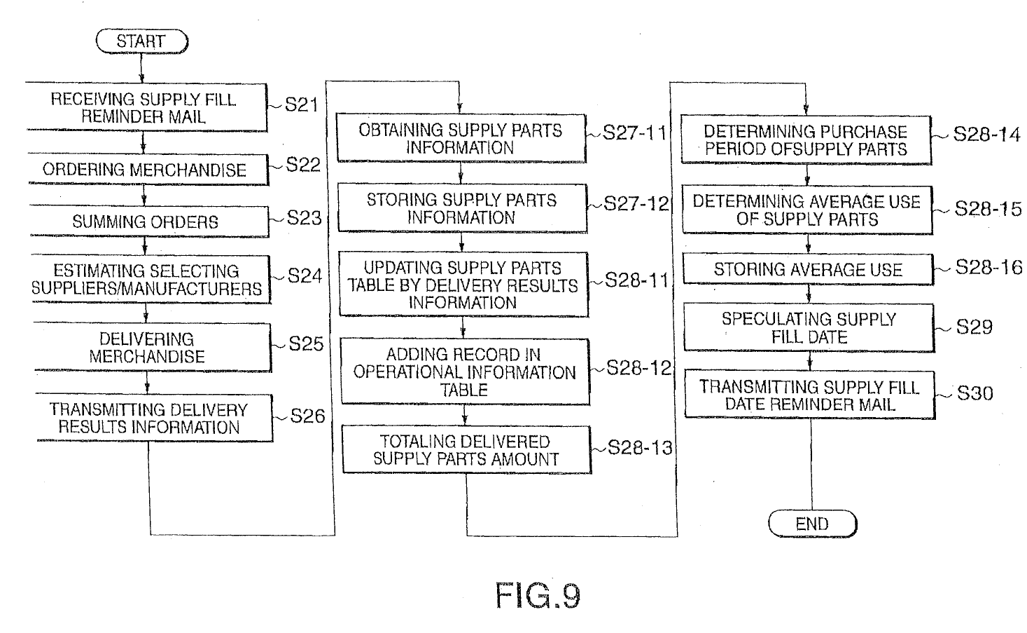

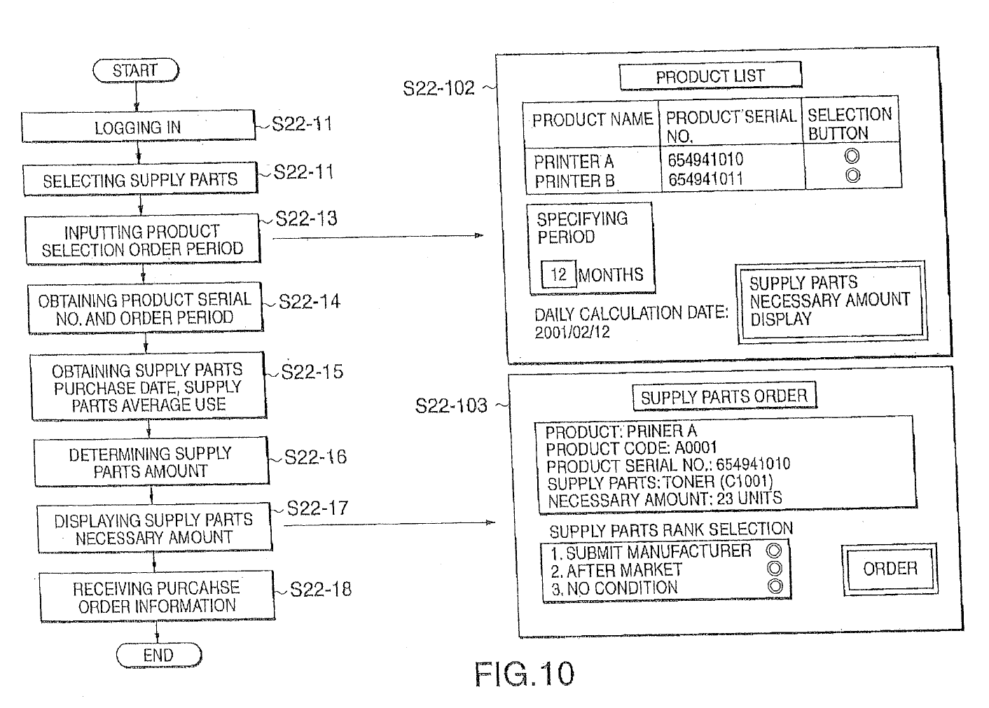

Now referring to FIG. 9, a flow chart illustrates steps involved in a preferred process of jointly purchasing supply parts according to the current invention. In a step S21, the client processing device 301 receives the supply parts replenish reminder e-mail from the intermediary processing device 300. Subsequently, the client inputs the information on the supply part order period and the rank such as manufacturer supply parts or aftermarket via the client processing device 301 and transmits a supply parts order to the intermediary processing device 300 in a step S22. Upon receiving the orders from the client processing units 301, the supply order unit 103 of the intermediary processing device 300 sums all of the supply parts orders with the help of the joint purchase processing unit 104 and sorts the supply orders by the similar supply replenish time frame in a step S23. In other words, the supply order unit 103 searches for a record in the supply parts order plan table 203c based upon a combined key of the product code as specified in the supply part order screen S22-103 and the supply parts rank. Upon finding a record having a matching month and a matching year between the client delivery date and the supply parts replenish date, the corresponding supply part purchase amount is added to the joint purchase amount. Furthermore, if the supply parts replenish date is later than the client delivery date, the supply parts replenish date is changed to the client delivery date. On the other hand, if no record is found to have the matching month and year, a new record is added. For example, it is assumed that the product code is “A0001” while the supply rank is “aftermarket” compatible supply part and that the supply replenish date is “Apr. 25, 2001.” It is further assumed that the supply parts order amount is 23 units while the current supply parts joint purchase amount is 42 units. After searching a matching record based upon the combination of “A0001” and “aftermarket” in the supply parts order plan table 203c as shown in FIG. 5, a matching record 203c-1 is found. Consequently, 23 units as will be shown in the supply part order screen S22-103 in FIG. 10 is added to the current supply parts joint purchase amount of 42 units so that the supply parts joint purchase amount is now 65 units.

Still referring to FIG. 9, the joint purchase processing unit 104 of the intermediary processing device 300 transmits the estimates to a plurality of suppliers and manufacturers who offers the above specified supply parts and receives the estimate responses. Among the responses, the joint purchase processing unit 104 selects a manufacturer or a supplier based upon the purchased price for the joint purchase amount and the delivery date in a step 24. Based upon the selection, the joint purchase processing unit 104 transmits a purchase order to the manufacturer processing device 303 or the supplier processing device 302 of the selected vendor. In response, the selected vender delivers the specified purchase amount to the client by the specified delivery date in a step S25. After the merchandise delivery, to the manufacturer processing device 303 or the supplier processing device 302 of the vendor transmits delivery result information to the intermediary processing device 300 in a step S26. The delivery result information includes the supplier code or the manufacturer code, the delivered supply parts code, the delivery date and the delivered amount. Based upon the delivery result information, the market information processing unit 107 of the intermediary processing device 300 updates the corresponding clients' purchase history information. In other words, the market information processing unit 107 receives the supplier code, the supply parts code and the delivery date from the supplier delivery result information data in a step S27-11. Subsequently, the market information processing unit 107 adds a new record in the purchase history table 205a and searches for a record that contains the matching information in the supply parts table 201b in a step S27-12. The supply parts manufacturer code, supply parts code and supply parts purchase date from the matched record in the supply parts table 201b are respectively stored as the previous manufacturer code, the previous merchandise code and the previous exchange/supply date in the newly added record in the purchase history table 205a in the step S27-12. Similarly, the supplier code, the supply parts code and the delivery date for the currently delivered supply parts as obtained in the step S27-11 are respectively stored as the current manufacturer code, the current merchandise code and the current exchange/supply date in the newly added record in the purchase history table 205a in the step S27-12.

For example, when the supply parts of a record 201b-1 in the supply parts table 201b is changed to a supply parts, “C 1003” of a record 204b-1 in the supply parts table 204b, a new record 205a-1 is added to the purchase history table 205a. Subsequently, the delivery information processing unit 108 of the intermediary processing device 300 updates the operational information and the monthly average use amount of the corresponding client. That is, the market information processing unit 107 of the intermediary processing device 300 updates the supply parts manufacturer code, supply parts code, supply parts purchase date and the supply parts purchase amount in the supply parts table 201b based upon the delivery result information from the manufacturer or the supplier in a step S28-11. Then, a new record is added to the operational information table 201c. Based upon the updated record content in the supply parts table 201b and the delivery result information, the market information processing unit 107 stores the client code, the product manufacturer code, the product code, the product serial numbers, the supply parts manufacturer code, the supply parts code, the supply purchase dates and the supply purchase amounts in a step S28-12.

The client code, the product manufacturer code, the product code, the product serial numbers of the newly added record in the operational information table 201c are used to search all matching records in order to determine the total supply parts purchase amount in a step S28-13. For example, records 201c-1 have the same values of the client code, “0002,” the product manufacturer code, “00002,” the product code, “B0002” and the product serial number, “353921001.” The total supply parts purchase amount of the records 201c-1 is 20 as the records 201c-1 respectively have the supply parts purchase amount of 7, 3, 4 and 6. Among the records 201c-1, the difference in month is determined between the oldest supply parts purchase date and the newest supply parts purchase date in a step S28-14. In this example, the difference is ten months since the oldest supply parts purchase date is Mar. 16, 2000 and the newest supply parts purchase date is Jan. 16, 2001. Then, the supply parts average use amount is determined in a step S28-15 by dividing the total supply parts purchase amount as determined in the step S28-14 by the difference as determined in the step S28-13. Still using the same example, the supply parts average use amount is two months since the total supply parts purchase amount is 20 units while the difference is 10 months. In a step S28-16, the above determined supply parts average use value of the step S28-15 is stored in the supply parts average use amount of the record as updated in the step S28-11 in the supply parts table 201b. If a record 201b-2 is added to the supply parts table 201b in the step S28-11, the result value, “2” is stored in the supply parts average use amount in the added record. The exchange/supply determination unit 102 determines the supply parts replenish date in a step S29 based upon the operation information as updated in the steps S28-11 through S28-16. The exchange/supply determination unit 102 transmits a corresponding client a purchase reminder about the supply parts replenish date in a step S30. The supply parts reminder includes information such as the product manufacturer code, the product code, the product serial number, the supply parts manufacturer code and the supply parts code for the supply parts that is detachable from the product. The above described joint purchase process is applicable to the product purchase as well as the parts purchase.

Now referring to FIG. 10, a flow chart further illustrates detailed steps involved in a preferred process of the merchandise order as shown in the step 22 of FIG. 9 according to the current invention. In a step S22-11, the client processing device 301 receives a client code or a password in a login screen from a client and performs a login procedure with the intermediary processing device 300. In response to a supply parts order in a client screen menu, the client processing device 301 refers to the information in the supply parts replenish reminder to obtain the product manufacturer code, the product code, the product serial number in a step S22-12. The client processing device 301 displays a product overview screen S22-102 that indicates the product and the product serial number for the detachable supply parts. The client processing device 301 receives from the client input information on a selected product and a order time frame for the supply parts order in a step S22-13. After receiving the selected product serial number and the selected order time frame, the client processing device 301 transmits the selected product serial number and the supply parts code in the supply parts replenish reminder mail to the intermediary processing device 300 in a step S22-14. The supply order unit 103 of the intermediary processing device 300 searches a matching record in the supply parts table 201b the based upon the received supply parts code and serial number to obtain the supply parts purchase date and the supply parts average use amount in a step S22-15. For example, Printer A having the product serial number of 654941010 is selected in the product overview screen S22-102. Using the selected product serial number “654941010,” the supply manufacturer code “00001,” and the supply parts code “C1001” in the supply parts replenish reminder mail, a matching record is searched in the supply parts table 201b. As a result of the search, a matching record 201b-1 is found as shown in FIG. 4, and the supply parts purchase date, “Feb. 25, 2001” and the supply parts average use amount, “3” are obtained from the above matched record.

Still referring to FIG. 10, in a step S22-16, the supply order unit 103 determines the supply parts purchase amount by multiplying the supply parts average use amount as obtained in the step S22-15 by a period of time. The period of time extends from the supply parts replenish date as determined in the step S29 in FIG. 9 to a selected end date for a time frame for the current supply parts order. The supply order unit 103 transmits of the intermediary processing device 300 transmits the above determined supply parts purchase amount to the client processing device 301 also in the step S22-16. For example, from a record 203a-1 in FIG. 5, the supply parts replenishment date is Apr. 25, 2001. Based upon FIG. 10, the selected end date is Feb. 11, 2002 since the selected daily calculation date is Feb. 12, 2001 and the time period is 12 months. The period of time is approximately 9.5 months between the selected end date, “Feb. 11, 2002” and the supply parts replenish date, “Apr. 25, 2001.” Using the above exemplary numbers, the number of supply parts necessary amount is approximately 23 units that are determined by multiplying the supply parts average use amount, “3” by the time period, “9.5” months minus the supply parts purchase amount, “6” as shown in the record 201b-1 of FIG. 4. The client processing device 301 receives the supply parts necessary amount as calculated in the step S22-16 and displays the received value in a supply parts order screen S22-103 in a step S22-17. In addition, the client processing device 301 also displays in the supply parts order screen S22-103 the product name, the product code, the product serial number and the supply parts name. After receiving a supply parts rank value and a submit order signal from the client in the supply parts order screen S22-103, the client processing device 301 transmits the order instructions to the intermediary processing device 300 in a step S22-18.

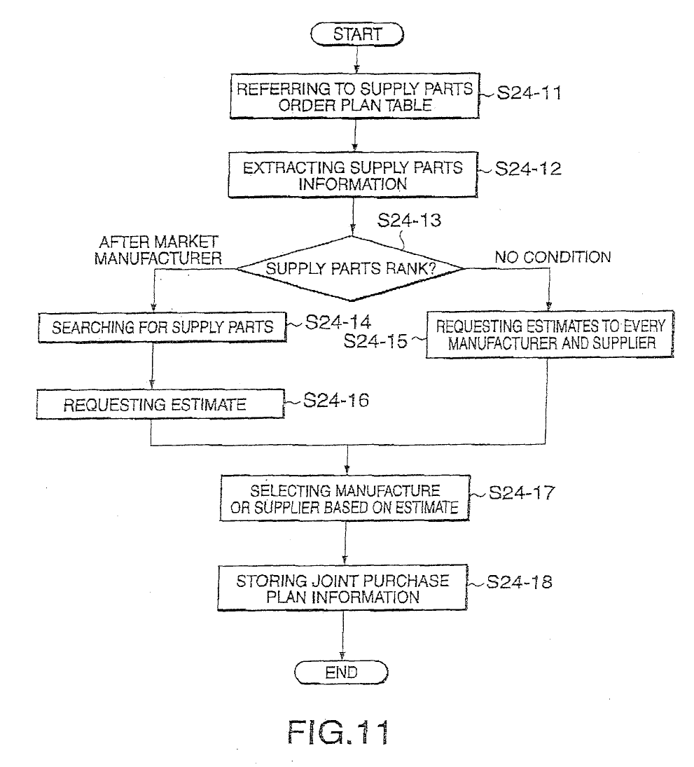

Now referring to FIG. 11, a flow chart further illustrates detailed steps involved in a preferred process of the vendor selection as shown in the step S24 of FIG. 9 according to the current invention. The joint purchase processing unit 104 of the intermediary processing device 300 reads one record at a time from the supply parts order plan table 203c and obtains the product code, the supply rank, the joint purchase amounts, the client delivery dates and the broker/intermediary delivery dates in a step S24-11. Based upon the product code that is obtained in the step S24-11, a record is searched in the product-supply parts compatibility table 204d in a step S24-12. For example, the product code, “A0001” is obtained from the record 203c-1 in the supply parts order plan table 203c as shown in FIG. 5. Records 204d-1 are found in the product-supply parts compatibility table 204d. Based upon the supply rank value of each record as read in the step S24-11, the preferred process determines the next step in a step 824-13. If the supply rank value is “After Market” or “Manufacturer's Product,” a supplier code is searched in a step S24-14 from the supply parts table 204b based upon the detachable supply parts manufacturer code, the detachable supply parts code and the above supply rank from the step S24-11 for each record. The above search in the step S24-14 enables to provide a list of suppliers and manufacturers who sell a supply part that is compatible with the above specified product. In a step S24-16, an estimate for the current supply parts order is requested to every one of the manufacturer processing units 303 and or the supplier processing units 302 that are found in the step S24-14. For example, the product code, “A0001” is obtained from the record 203c-1 in S24-11, and the supply rank is “After Market.” In the step S24-12, the three records 204d-1 are found based upon the above search criteria. Subsequently, two records 204b-1 are matched in the supply parts table 204b based upon the detachable supply parts manufacturer code, the detachable supply parts code and the above supply rank from the step S24-11. The two matched records 204b-1 indicate two supplier code values, “00001” and “00003” and the estimate is requested from the two suppliers. The processes of the manufacturer's product and after market are optionally independent and separate in another preferred embodiment.

Still referring to FIG. 11, the rest of the process continues as follows: On the other hand, if the supply rank value is “No Condition,” an estimate for the current supply parts order is requested in a step S24-15 to every one of the supplier processing units 302 and or the manufacturer processing units 303 that are found in the step S24-12. After the above described supply rank based steps are completed, the joint purchase processing unit 104 of the intermediary processing device 300 receives the estimate responses from the supplier processing units 302 and or the manufacturer processing units 303 and selects the least expensive manufacturer or supplier that meets the required broker delivery date in a step S24-17. Subsequently, the joint purchase processing unit 104 adds a record in the joint purchase plan supply parts table 203d and stores the supplier manufacturer code, the supply parts code, the joint purchase amount, the purchase unit cost and the broker/intermediary delivery date in the newly added record in a S24-18. For example, if the manufacturer or the supplier is “00001,” a record 203d-1 is added in the joint purchase plan supply parts table 203d.

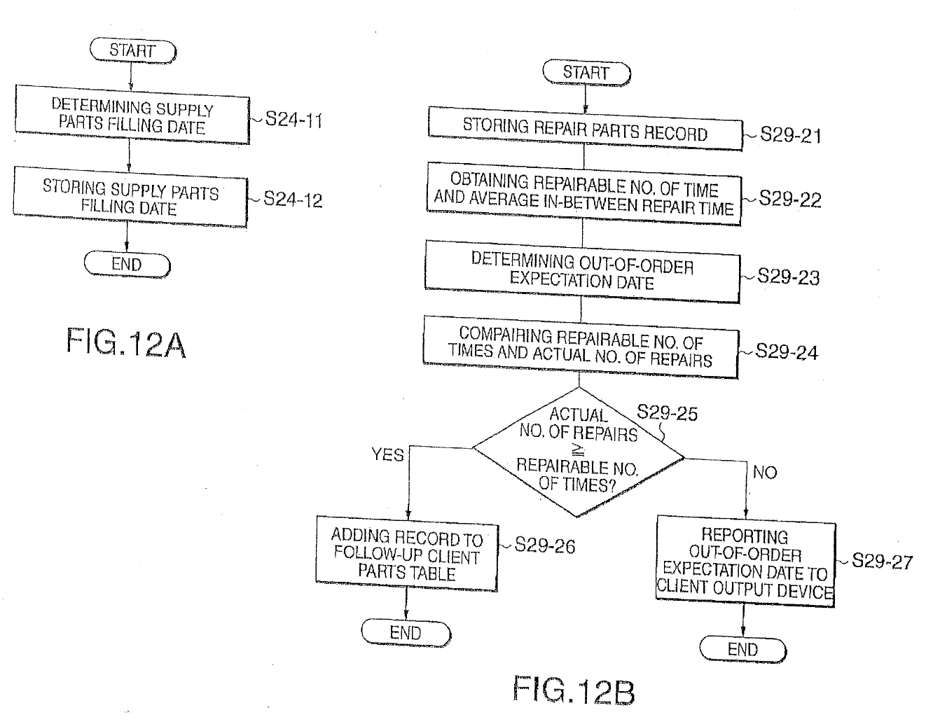

Now referring to FIG. 12, flow charts further illustrate detailed steps involved in preferred processes of speculating the supply parts replenishment date as shown in the step S29 of FIG. 9 according to the current invention. Referring particular to FIG. 12A, in one preferred process, the exchange/supply determination unit 102 of the intermediary processing device 300 determines a next supply part replenishment date in a step S29-11. The next supply part replenishment date is determined by adding a time period for the next supply purchase to the current supply parts purchase date. The time period is calculated by dividing the supply parts purchase amount by the supply parts average use amount, and the supply parts purchase amount is obtained from the record that has been updated in the supply parts table 201b. For example, the supply parts purchase amount, “6” in the record 201b-1 in the supply parts table 201b is divided by the supply parts average use amount, “3” to obtain two months. The above value, two months is added to the supply parts purchase date, Feb. 25, 2001 to further obtain Apr. 25, 2001, which is used as the supply parts replenishment date. Subsequently, a new record is added to the follow-up client supply parts table 203a in a step S29-12 to store the client code, the product manufacturer code, the product code, the product serial number, the supply parts manufacturer code, the supply parts code and the supply parts replenishment date as determined in the step S29-11. For example, the record 203a-1 in the follow-up client supply parts table 203a corresponds to the record 201b-1 in the supply parts table 201b.

Referring particular to FIG. 12B, another preferred process speculates a next out-of-service date based upon the parts maintenance/repair information and the average in-between malfunction length and intermediates the joint purchase of the parts according to the current invention. When a part is repaired or maintained, the exchange/supply determination unit 102 of the intermediary processing device 300 searches for a matching record in the maintenance information table 201d based upon the client code, the product manufacturer code, the product code, the product serial numbers, the parts manufacturer code, the parts code and the part serial numbers in a step S29-21. Upon finding a matching record, he exchange/supply determination unit 102 increments the number of repairs by one and updates the maintenance date by the new maintenance date in a step S29-21. Based upon the parts manufacturer code and the parts code, the part table 204c is searched in order to obtain the average in-between malfunction length and a number of repairable times in a step S29-22. For example, assuming that a record 201d-1 in the maintenance information table 201d contains the maintenance information on a currently repaired part, the part manufacturer code is “00003” while the part code is “00001.” When the above two code values are used for searching a matching record in the part table 204c, a record 204c-1 is found and contains the average in-between malfunction length, “2 years” and a number of repairable times, “3 times.” Based upon the above maintenance information, the average in-between malfunction length is added to the maintenance date to determine the out-of-service expectation date in a step S29-23. For example, the average in-between malfunction length, “2 years” as obtained in the step S29-23 is added to the maintenance date, “Nov. 24, 2000” to obtain the out-of-service expectation date, “Nov. 24, 2002.”

Still referring particular to FIG. 12B, the number of repairs as determined in the step S29-21 and the number of repairable times as obtained in the step S29-22 are compared in a step S29-24. For example, in a record 201d-1 in the maintenance information table 201d, the number of repairs has a value of 3, and the number of repairable times has a value of 3. In a step S29-25, it is determined whether the number of repairs is equal to or exceeds the number of repairable times. If the number of repairs has exceeded the number of repairable times, since it will not be possible to repair the part in a next malfunction, a new record is added in the follow-up client parts table 203b to store the client code, the product manufacturer code, the product code, the product serial number, the part code, the part serial number and the out-of-service expectation date in a step S29-26. On the other hand, if it is determined that the number of repairs has not yet exceeded the number of repairable times in the step S29-25, the out-of-service expectation date is transmitted to a corresponding one of the client processing units 301. The client processing units 301 displays the out-of-service expectation date in a step S29-27. For example, since the number of repairs, “3” in a record 201d-1 in the maintenance information table 201d is equal to the number of repairable times, a new record is added in the follow-up client parts table 203b.

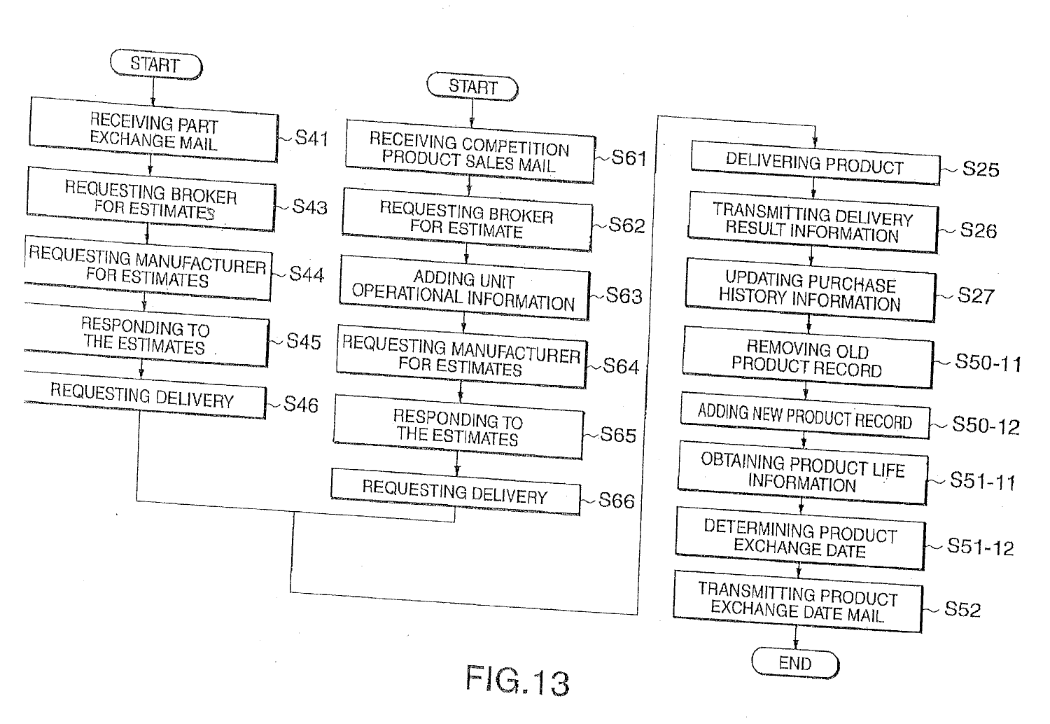

Now referring to FIG. 13, a flow chart further illustrates steps involved in a preferred process of matching negotiations according to the current invention. In general, when the intermediary processing device 300 reports the product exchange date to the client processing device 301, the clients' orders and the manufacturers' merchandise information are matched to make an agreement in steps S41 through S46. When the manufacturer processing device 303 registers the merchandise information and the intermediary processing device 300 sends the product sales information to the client processing device 301, the clients' orders and the manufacturers' merchandise information are matched to make an agreement in steps S61 through S66. Lastly, steps S25 through S27 and S50-11 through S52 take place after the manufacturer delivers the merchandise.

Still referring to FIG. 13, in reference to the steps S41 through S46, the client processing device 301 receives reports the product exchange date from the intermediary processing device 300. The client inputs the conditions and the manufacturer specification for the product purchase via the client processing device 301 and send for a product estimate to the intermediary processing device 300 in a step S43. Upon receiving the estimate request, the estimate/order request receiving unit 105 of the intermediary processing device 300 establishes the clients' product function and performance as well as the clients' needs, sales conditions and transmits the estimate requests to a plurality of the manufacturer processing units 303 via the negotiation matching processing unit 106 in a step 44. Upon receiving the estimate responses, the negotiation matching processing unit 106 processes the data in the multiple estimate responses and transmits the processed data to the client processing device 301 in a step S45. In case of a plurality of the estimate responses, the client selects one of the manufacturers via the client processing device 301 and transmits a purchase delivery request to the intermediary processing device 300 in a step S46. The negotiation matching processing unit 106 of the intermediary processing device 300 in turn transmits the purchase delivery request to the corresponding manufacturer processing device 303 of the selected manufacturer.

In reference to the steps S61 through S66, the intermediary processing device 300 refers to the client product component/unit information and transmits sales information on a newly registered product to the clients who use products that compete with the newly registered product. The clients receive the newly registered information in a step S61. The above clients are found by searching for a record in the unit component product table 201a based upon the competitor code and the manufacturer competitor product code in the product table 204a. In a step S62, the client considers the above received sales information. When an estimate is to be requested, new options for the product are inputted via the client processing device 301 and the estimate request is transmitted to the intermediary processing device 300. The estimate request receiving unit 105 of the intermediary processing device 300 receives the estimate request from the client processing device 301. The negotiation matching processing unit 106 adds the client product information in the unit operational management unit 101 to the above estimate in a step S63. In a step S64, the negotiation matching processing unit 106 transmits the above estimate to the manufacturer processing device 303 that offers the above product. The negotiation matching processing unit 106 receives the estimate response from the manufacturer processing device 303 and transmits the estimate response to the client processing device 301 for display in a step S65. The client confirms the content of the estimate response and inputs a delivery order request in the client processing device 301. The client processing device 301 in turn transmits the delivery order request to the intermediary processing device 300 in a step S66. The negotiation matching processing unit 106 in the intermediary processing device 300 transmits the delivery order request for the product to the manufacturer processing device 303 that offers the product.

Still referring to FIG. 13, either the steps S61 through S66 or the steps S41 through S46, the manufacturer delivers the ordered product to the client in a step S25. In a step S26, the manufacturer processing device 303 transmits the delivery information to the intermediary processing device 300 in a step S26. The delivery information includes the product manufacturer code, the delivered product code and the product serial number. The market information processing unit 107 of the intermediary processing device 300 updates the client's purchase history information in a step S27. The delivery information processing unit 108 of the intermediary processing device 300 updates the client's unit product information. That is, the delivery information processing unit 108 searches for a matching record in the unit component product table 201a, the supply parts table 201b and the operational information table 201c based upon the client code, the product manufacturer code, the product code and the product serial number, and the matched records are deleted in a step S50-11. Subsequently, a new record for the delivery is added to the unit component product table 201a, and the client code, the product manufacturer code, the product code, the product serial number and the product installment date are stored in the added record in a step S50-12. The exchange/supply determination unit 102 speculates a product exchange date based upon the operational information that has been updated in the above steps S50-11 through 50-12.

The exchange/supply determination unit 102 searches for a matching record in the product table 204a based upon the product manufacturer code and the product code of the delivery result information to obtain the number of years in the product life in a step S51-11. The above obtained product life in number of years from the step S51-11 is added to the product installment date in the delivery result information, and the summed date is used as the product exchange date in a step S51-12. For example, the product manufacturer code is “00001” while the product code is “A0001.” In the step S51-11, the product life, “6 years” is obtained from the matching record 204a-1 in the product table 204a. If the product installment date is Aug. 24, 2000, the above obtained product life, “6 years” is added to obtain Aug. 24, 2006 in a step S51-12. Similarly, the part exchange date is determined based upon the part life. One month before the exchange date for the product, a product exchange reminder mail is transmitted to the client in a step S52. The purchase reminder mail includes information on the product manufacturer code, the product code, the product name and the product serial number. Optionally, in combination with the steps S41 through S46 or the steps S61 through S66, the product exchange reminder and the new product sales information are together sent to a client upon a new purchase. That is, the negotiation matching processing unit 106 contacts the client about the competing product when the product exchange reminder is sent to the client.

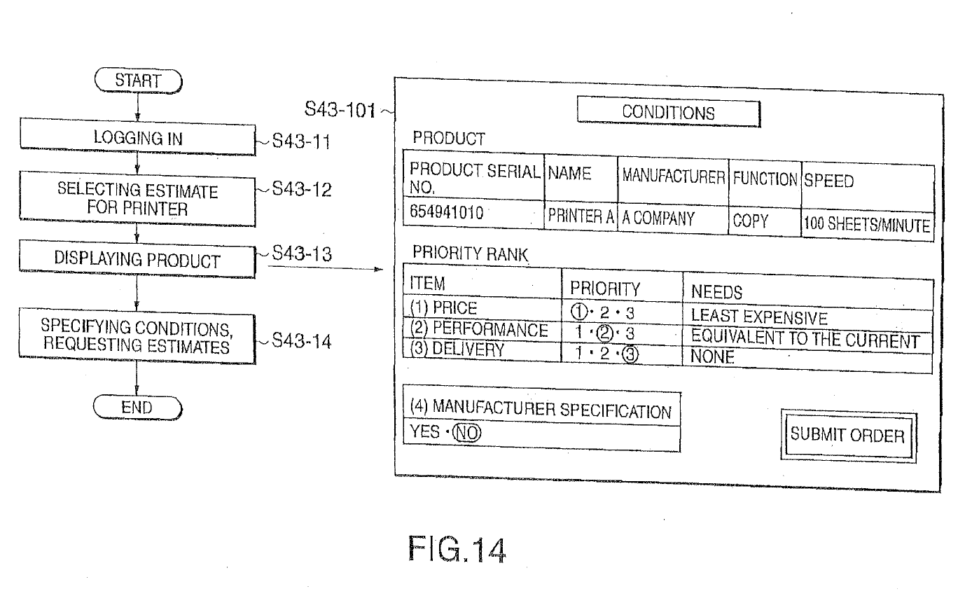

Now referring to FIG. 14, a flow chart and a diagram further illustrate detailed steps involved in preferred processes of the step S43 of FIG. 13 according to the current invention. The client processing device 301 receives the client code and a password via a log-in screen and initiates a long-in procedure with the intermediary processing device 30-0 in a step S43-11. Subsequently, upon receiving a selected printer product estimate via the client menu screen after detecting a request button, the client processing device 301 refers to the product exchange reminder mail and obtains information on the product manufacturer code, the product code, the product name and the product serial number in a step S43-12. The client processing device 301 displays information on the exchange product as specified by the product code, the product name and the product serial number in a condition screen S43-101 in a step S43-13. The client processing device 301 receives the needs and conditions from the client via the condition screen S43-101 and transmits the estimate request to the intermediary processing device 300 in a step S43-14.

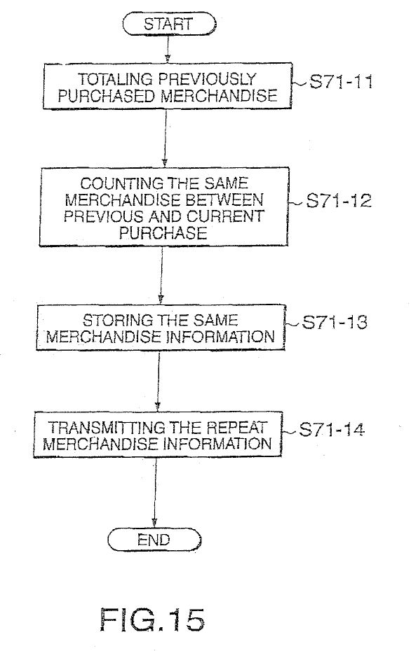

Referring to FIG. 15, a flow chart illustrates steps involved in a preferred process of generating market information according to the current invention. In general, the marketing information is generated to include repeat purchase information from the purchase history of the same merchandise for transmitting to manufacturers and suppliers. The market information processing unit 107 of the intermediary processing device 300 generates the repeat information by counting the same merchandise purchase in the purchase history data on a monthly basis and transmits the generated information. The repeat merchandise purchase information includes not only the product and supply parts purchase but also the parts purchase. At a predetermined time such as at the end of each month, the market information processing unit 107 counts a number of records that contain the same previous manufacturer code and the same previous merchandise code. That is, the same manufacturer and the same merchandise are counted in a step S71-11. Subsequently, in a step S71-12, a number of records that contain the same current and previous manufacturer code and the same current and previous merchandise code is counted in the purchase history table 205a. A record is added to the repeated information table 205b, and the manufacturer code, the merchandise code, the resulted count from the step S71-11 in the previous purchase amount and the resulted count from the step S71-12 in the current purchase amount in a step S71-13. For example, in the step S71-11, eight matching records are found to contain the previous manufacturer code, “00001” and the previous merchandise code, “C1001.” In the step S71-12, six matching records are found to contain the previous manufacturer code, “00001,” the previous merchandise code, “C1001,” the current manufacturer code, “00001,” the previous merchandise code, “C1001.” As a result, “00001” is stored in the manufacturer code while “C1001” is stored in the merchandise code. Similarly, “8” is stored in the previous purchase amount while 6 is stored in the current purchase amount. From the above data, the six of the eight customers repeated to purchase the same merchandise. In a step S71-14, the above information is transmitted to every one of the manufacturers and the suppliers that are stored in the purchase history table 205a and the repeated information table 205b.

An intermediary-assisted sales method that use the above described systems will be described based upon an industry example. The above described units and devices are referred in describing the industry example. An example of an appropriate sales industry for the use of the above described system is the brokers or intermediary sales agents who sell products such as photocopiers and printers as well as detachable supply parts such as toner and paper. In the application to the above described industry, the unit operation database 201 manages information on the clients' copier products and corresponding toner data, the copier installation dates and the toner use history data. The client database 202 manages information on clients who use copiers and printers. The follow-up client database 203 manages information on the client copier exchange dates, the toner replenishment date, the joint purchase prices and the delivery dates. The merchandise/product database 204 manages information on products such as copiers and printers, the function and performance/quality of the supply parts such as toner and paper, the compatibility between the product and the supply parts and the ranking of toner such as original manufacturer's product or aftermarket grades. The purchase history information 205 manages information on the merchandise purchase history data.

When a manufacturer or a supplier enters a merchandise into the system for sales, the merchandise management unit 109 stores or updates the performance/quality data of the copiers and the toner, the compatibility data between the copiers and the toner, the competing merchandise data and toner rank data. In addition to the manufacturers and the suppliers, sales companies dealing the above products are also entered into the system. When a client or a customer enters into the system to make a purchase, the unit operational management unit 101 registers the client characteristic information and the unit operational information. The exchange/supply determination unit 102 speculates the copier exchange date and the toner replenishment date. In approaching the toner replenishment date, the exchange/supply determination unit 102 transmits a replenishment reminder mail. The client orders toner by specifying the toner rank data and the order time frame. The supply order unit 103 receives the above order. The joint purchase processing unit 104 totals a number of toner purchase by ranks and common delivery time frames and requests a plurality of manufacturers and suppliers for an estimate. Among the estimates, a supplier or a manufacturer is selected based upon the purchase price for a joint purchase amount and the complying delivery requirement. When the supplier or the manufacturer delivers the merchandise to the client, the intermediary agent or the broker receives the delivery result information. The market information processing unit 107 updates the client purchase history based upon the delivery result information. The delivery information processing unit 108 updates the product unit/component information or the operation information based upon the delivery result information. The exchange/supply determination unit 102 speculates a client toner replenishment date and transmits a toner replenishment reminder mail one month prior to the client toner replenishment date.

Upon arriving a copier exchange date, the exchange/supply determination unit 102 transmits the client a copier exchange reminder mail. Upon receiving the reminder mail, the client specifies some conditions and needs for the copier change and requests the manufactures for an estimate. The estimate/order request receiving unit 105 receives the above requests, and the negotiation matching processing unit 106 adds the client specification and the current unit operational information before requesting the manufacturers for estimates. The manufacturers respond to the client by transmitting the estimate responses. The client selects one of the estimate responses from a plurality of the manufacturers and transmits delivery information to the intermediary agent. After the selected manufacturer delivers the specified merchandise to the client, the intermediary updates the purchase history information via the market information processing unit 107 based upon the delivery result information from the manufacturer. Also based upon the delivery result information, the delivery information processing unit 108 updates the client unit component information and the operational information. The exchange/supply determination unit 102 determines a client copier exchange date and transmits the client a copier exchange reminder one month prior to the client copier exchange date.

In transmitting the client the merchandise information on a registered merchandise, the intermediary uses the unit operational management unit 101 to search for the clients who utilize products that compete with the registered product and to transmit the merchandise sales information to the above discovered clients. Upon receiving the sales information, the client requests the intermediary for an estimate. The estimate/order request receiving unit 105 receives the estimate request, and the unit operational management unit 101 adds the client product unit component information. Then, the negotiation matching processing unit 106 request the manufacturers for an estimate. The manufacturers responds to the clients with an estimate response. The client transmits delivery request information to the intermediary. After the manufacturer delivers the specified merchandise to the client, the intermediary updates the purchase history information via the market information processing unit 107 based upon the delivery result information from the manufacturer. Also based upon the delivery result information, the delivery information processing unit 108 updates the client unit component information and the operational information. The exchange/supply determination unit 102 determines a client copier exchange date and transmits the client a copier exchange reminder one month prior to the client copier exchange date. In transmitting the client purchase history information and the market information from the intermediary to the manufacturers and the suppliers, the market information processing unit 107 is used to generate the above information at the end of each month and to transmit the information based upon a batch job.

In the above described preferred embodiment or method, the intermediary manages a plurality of clients' unit component and operational information. The product exchange date is determined based upon the product life data. The supply replenishment date is determined based upon the supply purchase history data. One month prior to the above dates, a reminder letter or e-mail is sent to the client so that an order is made on a timely basis. Furthermore, purchase orders are totaled for the same merchandise during the same delivery time frame, and the least expensive manufacturer is selected for the joint purchase so as to offer the merchandise at discounted prices. In receiving the product exchange order from the clients, since the intermediary manages the clients' current unit component information and the operational information, the information is added to the database. The manufacturers refer to the client unit component in order to prepare estimates. Furthermore, when a manufacturer introduce a new merchandise, since the manufacturer refers to the competing product information of other manufacturers, the sales information on the new product is transmitted to selected clients who utilize the target or competing products to solicit sales. By managing the market information and calculating the repeat information, the above information is offered to the manufacturers and the suppliers so that they have a good understanding of the switching product information and the repeat customer basis. Because of the time frame determination, the bidding of the purchase cost by a plurality of manufactures, the above described preferred method and embodiment enable to have the joint purchase of the merchandise that the clients need during a similar time frame at a reduce client cost due to the volume purchase. Furthermore, because of the joint purchase based upon the clients' needs, the reduced prices are offered for the merchandise that the clients need rather than the intermediaries or the manufacturers want to sell. The above joint purchase is substantially assured since the intermediary determines the time frame for purchase of the same merchandise during a common time frame for all the participating clients. The compatible information and the rank information enable to have a larger volume of joint purchase based upon the supply rank than the merchandise groupings.

In exchanging the products, the preferred method and embodiment enables to determine the needs and conditions while the client refers to the product unit component information and the operational information. This feature improves the efficiency and the quality in inputting the needs and conditions before transmitting the inputted information to the manufacturers. In addition, since manufacturers are selected for the estimate requests based upon the same information, the clients do not have to repeat the transmission of the information to manufacturers.

In introducing a new product, the manufacturer registers the function and performance and the competing products of other companies. The intermediary manages information of all the products that the clients use. That is, since customers who use the competing products are selectively searched, the new product sales information is transmitted to the selective clients in an efficient and assuring manner. The intermediary also manages the purchase history information based upon the unit component information, the operational information and the newest delivery result information. The purchase history information is organized to compare the pre-purchase manufacturer/merchandise information and the post-purchase manufacturer/merchandise information. Based upon the above purchase history information, the manufacturers and the suppliers accurately determine the clients who now purchase their merchandise instead of the competitors and the clients who now purchase their competitors instead of their products. The intermediary generates the purchase history information based upon the delivery result information. Unlike the information based upon questionnaires, the information is highly reliable due to the actually delivered product information. While the questionnaires by the manufacturers and the suppliers are generally conducted only on their own customers for their own merchandise, since the intermediaries deal with a plurality of manufacturers and suppliers, the intermediaries offer information that is not relied upon a particular manufacturer or a supplier. The intermediaries order a large volume of merchandise for a joint purchase and temporarily house the same. Since the intermediaries confirm with the clients for the orders based upon the clients' unit component information and the operational information, an amount of inventory and the associated risk for the order are minimized.

As described above, the first preferred embodiment of the intermediated merchandise sales system according to the current invention transmits reminders for the merchandise exchange date or the supply replenishment date and receives the orders in response to the reminders. The orders are totaled for the joint purchase, and the estimate requests are sent the manufacturers and the suppliers. The large volume order due to the joint purchase reduces the consumer costs for the merchandise. The second preferred embodiment of the intermediated merchandise sales system according to the current invention transmits reminders for the merchandise exchange date or the supply replenishment date and receives the orders in response to the reminders. Estimate requests are sent a plurality of the manufacturers and the suppliers. The intermediaries propose the plurality of the estimate responses to the clients in order to improve the negotiation efficiency. The third preferred embodiment of the intermediated merchandise sales system according to the current invention transmits sales information to the potential clients who use competing merchandise and receives the orders in response to the reminders. Estimate requests are sent a plurality of the manufacturers and the suppliers. The intermediaries propose the plurality of the estimate responses to the clients in order to improve the negotiation efficiency between the above targeted clients and the manufacturers or the suppliers.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A system for intermediating sales between merchandise manufacturers and clients, comprising:
a merchandise manufacturer processing unit for interfacing with the manufacturers;
a client processing unit for interfacing with the clients; and
an intermediary processing unit connected to said merchandise manufacturer processing unit and said client processing unit further comprising:
a database manager for maintaining a database that contains sales information of merchandises to the clients from the merchandise manufacturers;
an exchange/supply determination unit connected to said database manager for determining a purchase reminder date for certain merchandises for each of the clients, said exchange/supply determination unit transmitting a purchase reminder for the certain merchandises to corresponding ones of the clients at a predetermined amount of time prior to the purchase reminder date;
an order request receiving unit connected to said client processing unit for receiving purchase orders from the clients in response to the purchase reminder and for summing the purchase orders based upon predetermined criteria for a joint purchase; and
a joint purchase processing unit connected to said order request receiving unit for requesting estimates from at least one of the merchandise manufacturers for the joint purchase at a reduced unit price.

2. The system for intermediating sales between merchandise manufacturers and clients according to claim 1 wherein said database manager manages data on the merchandise including a part, a supply part and a product.

3. The system for intermediating sales between merchandise manufacturers and clients according to claim 2 wherein said database manager manages the sales information including a product installment date and a product life, said exchange/supply determination unit determining the purchase reminder date for the product based upon the sales information.

4. The system for intermediating sales between merchandise manufacturers and clients according to claim 2 wherein said database manager manages the sales information including a supply parts purchase date, a supply parts purchase amount and a supply parts average use amount, said exchange/supply determination unit determining the purchase reminder date for the supply part based upon the sales information.

5. The system for intermediating sales between merchandise manufacturers and clients according to claim 2 wherein said database manager manages the sales information including a part maintenance date, an average in-between malfunction length and a number of repairs, said exchange/supply determination unit determining the purchase reminder date for the part based upon the sales information.

6. The system for intermediating sales between merchandise manufacturers and clients according to claim 1 wherein said exchange/supply determination unit transmitting a purchase reminder for the certain merchandises to corresponding ones of the clients one month prior to the purchase reminder date.

7. The system for intermediating sales between merchandise manufacturers and clients according to claim 2 further comprising:
said client processing unit for displaying the merchandise reminder to the client; and
said joint purchase processing unit selecting at least one of the merchandise manufacturers to order for the joint purchase based upon the estimates from a plurality of the merchandise manufacturers.

8. The system for intermediating sales between merchandise manufacturers and clients according to claim 7 wherein said database manager manages the sales information including rank information, the delivery orders including the rank information that is selected by the clients, said joint purchase processing unit summing the purchase orders for the joint purchase based upon the rank information.

9. The system for intermediating sales between merchandise manufacturers and clients according to claim 7 wherein said exchange/supply determination unit determines a purchase amount of the certain merchandises for transmitting in the merchandise reminder.

10. The system for intermediating sales between merchandise manufacturers and clients according to claim 9 wherein said database manager manages the sales information including a supply parts purchase date, a supply parts purchase amount and a supply parts average use amount, said exchange/supply determination unit determining the purchase amount for the supply part based upon the sales information.

11. The system for intermediating sales between merchandise manufacturers and clients according to claim 1 wherein said client processing unit and said database manager register the clients in the database, merchandise manufacturer processing unit and said database manager register the merchandise manufacturers in the database.

12. A system for generating market information in intermediating sales between merchandise manufacturers and clients, comprising:
a merchandise manufacturer processing unit for interfacing with the manufacturers;
a client processing unit for interfacing with the clients; and
an intermediary processing unit connected to said merchandise manufacturer processing unit and said client processing unit further comprising:
a database manager for maintaining a database that contains sales information of merchandises to the clients from the merchandise manufacturers;
an order request receiving unit connected to said client processing unit for receiving purchase orders from the clients and for generating deliver orders to the merchandise manufacturer processing unit based upon the purchase orders from the clients; and
a delivery information processing unit connected to said merchandise manufacturer processing unit for receiving delivery results information from the merchandise manufacturers after the merchandise manufacturers deliver the merchandises to the clients; and
a market information processing unit connected to said delivery information processing unit for generating market information based upon the delivery results information and the sales information.

13. The system for generating market information according to claim 12 wherein said database manager maintains the sales information including a purchase history table.

14. The system for generating market information according to claim 13 wherein said database manager maintains the market information including repeat purchase data by the clients.

15. The system for generating market information according to claim 12 wherein the merchandise manufacturers include product manufacturers, supply parts manufacturers and parts manufacturers.

16. The system for generating market information according to claim 15 wherein said market information processing unit transmits the market information to said merchandise manufacturer processing unit.

17. The system for generating market information according to claim 13 wherein said market information processing unit generates the market information including client data indicative of certain potential clients purchasing competing merchandises.

18. The system for generating market information according to claim 17 wherein said market information processing unit transmits the client data to said merchandise manufacturer processing unit.

19. The system for generating market information according to claim 17 further comprising a negotiation matching processing unit connected to said delivery information processing unit for transmitting the potential clients certain sales information on certain other merchandises.

20. The system for generating market information according to claim 17 further comprising:
an exchange/supply determination unit connected to said database manager for determining a purchase reminder date for certain merchandises for each of the clients, said exchange/supply determination unit transmitting a purchase reminder for the certain merchandises to corresponding ones of the clients at a predetermined amount of time prior to the purchase reminder date.

21. The system for generating market information according to claim 20 further comprising a negotiation matching processing unit connected to said delivery information processing unit for transmitting the potential clients certain sales information on certain other merchandises upon transmitting the purchase reminder.
